(19) United States
(12) Patent Application Publication
(10) Pub. No.: US 2025/0359549 A1
(43) Pub. Date: Nov. 27, 2025

(54) PESTICIDE BACTERICIDAL COMPOSITION, WATER DISPERSIBLE GRANULE AND PREPARATION METHOD AND USE THEREOF

(71) Applicant: QINGDAO RAINBOW CHEMICAL CO., LTD., Shandong (CN)

(72) Inventors: Zhiqing LI, Shandong (CN); Jianwei WANG, Shandong (CN); Yanlin LEI, Shandong (CN); Peng SUN, Shandong (CN); Guangfei JI, Shandong (CN)

(73) Assignee: QINGDAO RAINBOW CHEMICAL CO., LTD., Shandong (CN)

(21) Appl. No.: 19/298,115

(22) Filed: Aug. 12, 2025

Related U.S. Application Data
(63) Continuation of application No. PCT/CN2024/086823, filed on Apr. 9, 2024.

(30) Foreign Application Priority Data
Apr. 14, 2023 (CN) 202310400929.2

(51) Int. Cl. A01N 43/653; A01N 25/04; A01N 37/34; A01N 43/40; A01P 1/00

(52) U.S. Cl. CPC A01N 43/653; A01N 25/04; A01N 37/34; A01N 43/40; A01P 1/00

(57) ABSTRACT

The present application discloses a pesticide bactericidal composition, a water dispersible granule and a preparation method and a use thereof, and relates to the field of pesticides. The active ingredients of the pesticide bactericidal composition comprise chlorothalonil, tebuconazole and picoxystrobin with a weight ratio of (10-50):(1-2):1, optionally (10-20):(1-6):(1-3), optionally (10-20):(1-2):1 or 10:6:3. The ternary compounded composition of the present application has a synergistic effect in the aspect of preventing and controlling plant diseases, and can achieve above 90% of prevention and control effect of grape downy mildew and wheat powdery mildew. The ratios of the composition in the present application can allow pesticides to better exert a synergistic effect, thereby reducing the usage amount of the pesticides and improving the efficacy.

### CROSS-REFERENCE TO RELATED APPLICATION

This application is a continuation of international application of PCT application serial no. PCT/CN2024/086823,filed on Apr. 9, 2024,which claims the priority benefit of China application no. 202310400929.2,filed on Apr. 14, 2023.The entirety of each of the above-mentioned patent applications is hereby incorporated by reference herein and made a part of this specification.

### TECHNICAL FIELD

The present application relates to the field of pesticides, particularly to a pesticide bactericidal composition, a water dispersible granule and a preparation method and a use thereof.

### BACKGROUND ART

Chlorothalonil is a non-systemic broad-spectrum bactericide. Chlorothalonil can react with glyceraldehyde-3-phosphate dehydrogenase in fungal cells, bind to proteins containing cysteine in this enzyme body, disrupt the vitality of the enzyme, and cause the loss of the vitality of the fungal cells due to disruption of their metabolism. After the plant has been invaded by pathogens and pathogens enter the plant body, the bactericidal effect is weak. Chlorothalonil has no systemic conduction effect, and cannot be absorbed from sprayed parts and roots of plants. Chlorothalonil has good adhesion on the surfaces of plants and is not easily washed away by rainwater, thus it has a relatively long efficacy period. Prevention and control objects: to prevent and control various fungal diseases, as well as industrial corrosion removers or fruit preservatives. Suitable crops: wheat, soybeans, peanuts, rice, vegetables, fruit trees, etc. Chlorothalonil: the pure product is a colorless and odorless crystalline solid, and the original pesticide has slightly irritating odor; it has a melting point of 252.1° C., a distribution coefficient of log P=2.92 (25° C.), a relative density of 2.0,and a solubility in water (25° C.) of 0.81 mg/L. Stability: chlorothalonil is stably stored at room temperature, and stable to weak alkaline and acidic aqueous solutions and UV radiation. It is slowly hydrolyzed at pH>9.

Tebuconazole is an ergosterol biosynthesis inhibitor. It can be quickly absorbed by parts of plants that have growth ability and mainly transferred to the top. Not only does it have bactericidal activity, but it can also promote plant growth so that root systems are developed, leaves are dark green, plants are strong, and effective tillering is increased, thereby increasing the yield. Prevention and control objects: it can prevent and control diseases caused by powdery mildew, puccinia, coracoid, sclerotium and shell needle fungus, such as wheat powdery mildew, rice loose smut, wheat sharp eyespot, sorghum head smut, wheat snow molds, wheat take-all, bunt of wheat, rhynchosporium secalis davis, barley sheath blight, maize head smut, soybean rust, rape sclerotium, sigatoka, tea blister blight, apple alternaria leaf spot, pear scab, grape black mold, etc. Suitable crops: wheat, barley, oats, rye, corn, sorghum, peanuts, bananas, grapes, tea, fruit trees, etc. Tebuconazole: this product is a racemic mixture, and the pure product is a colorless crystal (the original pesticide is a light brown powder) and has a melting point of 105° C., a vapor pressure of 1.7×10⁻³ mPa (20° C.), a partition coefficient of log P=3.7 (20° C.), a relative density of 1.25, a solubility in water of 36 mg/L (pH 5-9, 20° C.), a solubility in an organic solvent (g/L, 20° C.): dichloromethane>200,isopropanol, toluene 50-100 and hexane<0.1,and a hydrolysis half-life DT50 of >1 a (pH 4-9, 22° C.).

Picoxystrobin is a mitochondrial respiratory inhibitor for inhibiting mitochondrial respiration through electron transfer between cytochrome b and C1,and is effective in preventing and controlling strains resistant to 14-demethylated enzyme inhibitors, benzamides, dicarboxylamides and benzimidazoles. Prevention and control objects: broad-spectrum, systemic bactericide. It is mainly used for prevention and control of wheat leaf diseases such as leaf blight, leaf rust, glume blotch, powdery mildew, etc. Compared with the existing strobilurin bactericides, it has a stronger therapeutic effect on wheat leaf blight, net blotch and scald disease. Suitable crops: wheat, barley, oats, ryes, etc; safety, and pesticide disease free for crops at recommended doses. Picoxystrobin: the pure product is a white powdery solid with a melting point of 75° C., a relative density of 1.4 (20° C.), a steam pressure of 5.5×10⁻⁶ Pa, a partition coefficient of Kowlog P=3.6 (20° C.), Henry's constant of 6.5×10⁻⁴ Pam³mol⁻¹, a solubility in water of 3.1 mg/L (20° C.). Picoxystrobin is stable at pH 5 and pH 7.

The bactericide varieties with a single active ingredient often have varying degrees of defects in prevention and control of agricultural diseases. For example, after continuous use, pathogens are prone to developing pesticide resistance, and frequent use can exacerbate environmental pollution. In addition, the original pesticide of picoxystrobin easily forms non-disintegrating particles due to a low melting point (a melting point of 75° C.). There is a situation that a large amount of fine powders fail to pass a sieve during a wet screening test, resulting in poor manufacturability and thermal storage stability, so as to pose certain difficulties in the processing of water dispersible granule formulations.

Therefore, it is necessary to develop a novel bactericide capable of solving the above problems.

### SUMMARY

### Objective of the Invention

In order to overcome the above defects, the objective of the present application is to provide a pesticide bactericidal composition, a water dispersible granule and a preparation method and a use thereof. The ternary compounded composition of the present application has a synergistic effect in preventing and controlling plant diseases, and has a prevention and control effect of over 90% in preventing and controlling grape downy mildew and wheat powdery mildew. The ratios of the composition of the present application can better exert a synergistic effect of the pesticide, thereby reducing the usage amount of the pesticide and improving the efficacy.

### Solution

To achieve the objective of the present application, the technical solution adopted by the present application is as follows:

In a first aspect, the present application provides a pesticide bactericidal composition, comprising the following active ingredients: chlorothalonil, tebuconazole and picoxystrobin with a weight ratio of (10-50):(1-6):(1-3).

Further, the weight ratio of chlorothalonil, tebuconazole and picoxystrobin is (10-20):(1-6):(1-3), optionally (10-20):(1-2):1 or 10:6:3,optionally (18-20):2:1 or 10:6:3,optionally 10:6:3, 10:1:1, 20:2:1 and 18:2:1;
and/or, the weight ratio of chlorothalonil to tebuconazole is (9-10):1,preferably when the weight ratio of chlorothalonil, tebuconazole and picoxystrobin is (10-20):(1-2):1,the weight ratio of chlorothalonil to tebuconazole is (9-10):1.

Further, the active ingredients account for 1-99%, optionally 20%- 80%, optionally 30%-70%, optionally 50%- 70%, optionally 38%- 63.3%, of the total weight of the composition.

Further, the dosage form of the pesticide bactericidal composition is one or more of a missible oil, a microcapsule suspension-suspending agent, a suspension emulsion, an emulsion in water, a microemulsion, a soluble concentrate or a wettable powder;
optionally, the pesticide bactericidal composition further comprises an adjuvant,
optionally, the adjuvant is one or more selected from the group consisting of a dispersant, a wetting agent, an emulsifier, a solvent, a cosolvent, an antifreeze, a chelating agent, a disintegrant, a stabilizer, a preservative, a thickener, a binder, a defoamer, an acid adjusting medium, an alkali adjusting media, and a solid inert carrier.

In a second aspect, the present application provides a pesticide bactericidal water dispersible granule, comprising the following raw materials in percentage by weight: 10-60% of chlorothalonil, 1-10% of tebuconazole, 1-10% of picoxystrobin, 6-10% of a dispersant, 2-6% of a wetting agent, 2-4% of a chelating agent, 10-20% of a disintegrant and the balance being a filler.

Further, the pesticide bactericidal water dispersible granule comprises the following raw materials in percentage by weight: 30-60% of chlorothalonil, 1-10% of tebuconazole, 1-10% of picoxystrobin, 9-10% of a dispersant, 3-5% of a wetting agent, 3-4% of a chelating agent, 10-20% of a disintegrant and the balance being a filler.

Optionally, the pesticide bactericidal water dispersible granule comprises the following raw materials in percentage by weight: 30-60% of chlorothalonil, 1-10% of tebuconazole, 1-10% of picoxystrobin, 9-10% of a dispersant, 4% of a wetting agent, 3% of a chelating agent, 10-20% of a disintegrant and the balance being a filler.

Optionally, the pesticide bactericidal water dispersible granule comprises the following raw materials in percentage by weight: 30-54% of chlorothalonil, 1-6% of tebuconazole, 1-5% of picoxystrobin, 9-10% of a dispersant, 4% of a wetting agent, 3% of a chelating agent, 10-20% of a disintegrant and the balance being a filler.

Optionally, the pesticide bactericidal water dispersible granule comprises the following raw materials in percentage by weight: 30-54% of chlorothalonil, 1-6% of tebuconazole, 1-3.3% of picoxystrobin, 9-10% of a dispersant, 4% of a wetting agent, 3% of a chelating agent, 10-20% of a disintegrant and the balance being a filler.

Optionally, the pesticide bactericidal water dispersible granule comprises the following raw materials in percentage by weight: 30-60% of chlorothalonil, 1-10% of tebuconazole, 1-10% of picoxystrobin, 10% of a dispersant, 4% of a wetting agent, 3% of a chelating agent, 20% of a disintegrant and the balance being a filler.

Optionally, the pesticide bactericidal water dispersible granule comprises the following raw materials in percentage by weight: 30-54% of chlorothalonil, 1-6% of tebuconazole, 1-5% of picoxystrobin, 10% of a dispersant, 4% of a wetting agent, 3% of a chelating agent, 20% of a disintegrant and the balance being a filler.

Optionally, the pesticide bactericidal water dispersible granule comprises the following raw materials in percentage by weight: 50-54% of chlorothalonil, 1-6% of tebuconazole, 1-3.3% of picoxystrobin, 10% of a dispersant, 4% of a wetting agent, 3% of a chelating agent, 20% of a disintegrant and the balance being a filler.

Optionally, the pesticide bactericidal water dispersible granule comprises the following raw materials in percentage by weight: 54% of chlorothalonil, 6% of tebuconazole, 3.3% of picoxystrobin, 10% of a dispersant, 4% of a wetting agent, 3% of a chelating agent, 20% of a disintegrant and the balance being a filler.

In the pesticide bactericidal composition according to the first aspect or the pesticide bactericidal water dispersible granule according to the second aspect, the dispersant is one or more selected from the group consisting of styrene-acrylic acid copolymer sodium salt, methylnaphthalene sulfonic acid-formaldehyde concentrate sulfate, naphthalene sulfonic acid-formaldehyde condensate sodium salt, methylene naphthalene sodium sulfonate-dibutylnaphthalene sulfonic acid-formaldehyde concentrate, sodium N-methyl fatty acyl taurine, alkylnaphthalene sulfonate-formaldehyde concentrate, alkylphenol ethoxylate-formaldehyde concentrate sulfate and sodium lignosulfonate, preferably, styrene-acrylic acid copolymer sodium salt and sodium lignosulfonate, preferably in the dispersant, a weight ratio of styrene-acrylic acid copolymer sodium salt to sodium lignosulfonate is (1-2):1,preferably 1:1;
in the pesticide bactericidal composition according to the first aspect or the pesticide bactericidal water dispersible granule according to the second aspect, the wetting agent is one or more selected from the group consisting of sodium dodecyl sulfate, a-sulfo fatty acid methyl ester, sodium tetradecyl sulfate, sodium dodecyl benzenesulfonate, sodium alkylnaphthalene sulfonate, sodium a-olefin sulfonate, a polymer of olefin and maleic anhydride, sodium alkylphenol polyoxyethylene ether sulfate, sodium diisobutylnaphthalene sulfonate, fatty acid sulfate and fatty acid ester sulfate, optionally a polymer of olefin and maleic anhydride and/or sodium diisobutylnaphthalene sulfonate;
in the pesticide bactericidal composition according to the first aspect or the pesticide bactericidal water dispersible granule according to the second aspect, the chelating agent is one or more selected from the group consisting of sodium tripolyphosphate, sodium gluconate, sodium pyrophosphate and disodium ethylenediaminetetraaceticate, optionally disodium ethylene diamine tetraaceticate and/or sodium tripolyphosphate;
in the pesticide bactericidal composition according to the first aspect or the pesticide bactericidal water dispersible granule according to the second aspect, the disintegrant is one or more selected from the group consisting of urea, sodium sulfate, ammonium sulfate, calcium chloride, potassium dihydrogen phosphate and diammonium hydrogen phosphate, optionally diammonium hydrogen phosphate and/or ammonium sulfate;
in the pesticide bactericidal composition according to the first aspect or the pesticide bactericidal water dispersible granule according to the second aspect, the filler comprises one or more selected from the group consisting of talcum powder, corn starch, kaolin, silica and kieselguhr; optionally, talcum powder and/or kaolin;

As a preferred embodiment, in the pesticide bactericidal composition according to the first aspect or the pesticide bactericidal water dispersible granule according to the second aspect, the dispersant includes styrene-acrylic acid copolymer sodium salt and sodium lignosulfonate with a weight ratio of (1-2):1 (preferably 1:1); preferably, the wetting agent is a polymer of olefin and maleic anhydride and/or sodium diisobutylnaphthalene sulfonate; preferably, the chelating agent is disodium ethylenediaminetetraacetate and/or sodium tripolyphosphate; preferably, the disintegrant is diammonium hydrogen phosphate and/or ammonium sulfate preferably, the filler is talcum powder and/or kaolin.

The pesticide bactericidal composition according to the first aspect or the pesticide bactericidal water dispersible granule according to the second aspect comprises a dispersant, a wetting agent, a chelating agent and a disintegrant with a weight ratio of (5-20):(3-8):3:(5-30), optionally (9-15):(4-8):3:(10-25), optionally (9-10):4:3:(10-20), optionally 10:4:3:20,optionally further comprises a filler.

In a third aspect, the present application provides a method for preparing the pesticide bactericidal composition according to the first aspect or the pesticide bactericidal water dispersible granule according to the second aspect, comprising:
evenly mixing chlorothalonil, tebuconazole, picoxystrobin and the adjuvants, and then performing ultrafine airflow pulverization on the obtained mixture to obtain fine powders, mixing the obtained fine powders with water and then kneading the obtained mixture, performing extrusion granulation on the mixture after kneading, and then drying the obtained granules to obtain a water dispersible granule product containing chlorothalonil, tebuconazole and picoxystrobin.

Further, the fineness of the fine powders after ultrafine airflow pulverization is 400-800 meshes.

Further, the addition amount of water to the fine powders is 16-22% of the total amount of materials. The materials refer to water and fine powders.

Further, the drying temperature after granulation is 45-55° C.

In a fourth aspect, the present application provides a use of the pesticide bactericidal composition according to the first aspect, or the pesticide bactericidal water dispersible granule according to the second aspect, or the water dispersible granule prepared by using the method according to the third aspect in preventing and controlling plant diseases in agricultural fields; optionally, the plant diseases include one or more of downy mildew, powdery mildew, grey mold and rust; optionally, the plant diseases include one or more of grape downy mildew, wheat powdery mildew and soybean rust.

### Beneficial Effects

(1) The ternary compounded composition of the present application has a synergistic effect in preventing and controlling plant diseases, and has a prevention and control effect of over 90% in preventing and controlling grape downy mildew and wheat powdery mildew. The ratios of the composition of the present application patent can better exert a synergistic effect of the pesticide, thereby reducing the usage amount of the pesticide and improving the efficacy.
(2) The present application solves the problem of thermal storage instability caused by low original melting point through the screening of adjuvants. The inventors obtained the best matching system by screening of a large number of adjuvants, especially screening and combination of a dispersant, a wetting agent, a stabilizer and a filler. The specific combination ratio of a dispersant is matched with the specific combination ratio of a wetting agent to obtain the optimal formula combination so as to ensure that the water dispersible granule is adapted to multiple water qualities and have the advantages of low foaming ability and high suspension rate and the like, and the optimal system combination of a stabilizer and a filler greatly reduces the processing difficulty of the dosage form and improves the stability of the dosage form, and the adjuvants of the present application together with the active ingredients of the pesticide has synergistic effects.

### DESCRIPTION OF THE EMBODIMENTS

To make the objective, technical solution and advantages of the present application more clear, the technical solution in examples of the present application will be clearly and completely described below, the described examples are some examples of the present application but not all the examples. Based on the examples in the present application, other examples obtained by persons of ordinary skill in the art without creative efforts are all included within the scope of protection of the present application.

In addition, in order to better illustrate the present application, many specific details are given in specific examples hereafter. Those skilled in the art should understand that the present application can be similarly implemented even though there are no some specific details. In some examples, raw materials, solutions, methods, means and the like familiar with those skilled in the art are not described in detail so as to highlight the main idea of the present application.

Unless otherwise explicitly stated, the term “include” or transformations thereof such as “comprise” or “comprising” will be understood as including the stated elements or compositions, without excluding other elements or other compositions.

The above bactericidal composition provides a new choice for preventing and controlling plant diseases. Next, the present application will be further illustrated through examples, however, the present application is not limited thereto.

Chlorothalonil, picoxystrobin and tebuconazole in examples below are all commercially available, and other adjuvants are also commercially available.

The present application will be further illustrated in detail through examples.

### Test Example 1 Indoor Toxicity Measurement

The measurement of the compounding of chlorothalonil, picoxystrobin and tebuconazole on indoor toxicity of plasmopara viticola was carried out by using a leaf disk method:
(1) a spore sac suspension was prepared, fresh grape downy mildew leaves were collected, the old mildew layer on the diseased leaves was brushed off with a brush under running water, the leaves with upward backs were upward laid in a moisturizing disk with two layers of absorbent gauze at the bottom, the moisturizing disk was sealed with a plastic film, and placed in an artificial climate incubator for culture, wherein the culture conditions were as follows: 18° C., a relative humidity of 90%, and alternating light and dark (12 h for light and 12 h for darkness). After new spore sacs on scabs grow, the new spore sacs were rinsed with distilled water and then diluted to prepare a spore sac suspension of 1×10⁵ spore sacs/mL for later use.
(2) Pesticide treatment was carried out before 24 h of inoculation prior to indoor toxicity measurement. Different treatment pesticide solutions were respectively sprayed onto the back of leaf discs with a diameter of 1.5 cm. After the pesticide solution was naturally dried in air, each treated leaf disc with an upward back was placed in a culture dish, and absorbent paper moistened with the same pesticide solution was placed at the bottom of the culture dish. 15 leaf discs were placed in a concentric circle for each dish, with 4 repetitions for 1 dish treated. Blank control was treated with a 0.1% Tween-80 aqueous solution. Inoculation was performed after 24 h of pesticide treatment. The spore sac suspension was inoculated to the center of the leaf disc by using a pipette, with 20 μL of suspension in each leaf disc. The spore sac suspension was cultured with an artificial climate chamber. The culture conditions: a temperature of 22° C., a relative humidity of 90%, and alternating light and dark (12 h for light and 12 h for darkness).
(3) Survey method: survey results were obtained when control was cultured until homogeneous morbidity occurred. The severity of the disease was determined according to the percentage of the diseased area on the leaf disc to the leaf disc area, the number of diseased leaf discs and the severity of the disease were recorded, and the disease index and prevention and control effect were calculated according to the formula.

Severity grading criteria for diseases: Level 0: no lesions; Level 1 : the lesion area accounts for 5% or less of the entire leaf area; Level 3: the lesion area accounts for 6%- 25% of the entire leaf area; Level 5: the lesion area accounts for 26%- 50% of the entire leaf area; Level 7: the lesion area accounts for 51%- 75% of the entire leaf area; Level 9: the lesion area accounts for over 76% of the entire leaf area.
(4) Data processing and analysis were conducted by using the logarithmic value of pesticide concentration as the independent variable x and the probability value of the prevention and control effect as the dependent variable y for regression analysis. The toxicity regression curve equation y=a+bx and the correlation coefficient r were obtained, and the EC₅₀ of each single agent and different proportions of mixtures was calculated based on the regression equation.

Based on the EC₅₀ values of each single agent and compounded agent, the synergistic coefficients (SR) of each compounded agent were calculated according to Wadley method, and the compounding effect was evaluated by using SR value. SR≥1.5 indicates a synergistic effect; SR≤0.5 indicates antagonism; 0.5<SR<1.5 indicates additive action.

The synergistic coefficient (SR) of the ternary composition was calculated according to equations (1) and (2).

$${X}_{1} = \frac{PA + PB + PC}{\frac{PA}{A} + \frac{PB}{B} + \frac{PC}{C}} \qquad ( 1 )$$

$$SR = \frac{X 1}{X 2} \qquad ( 2 )$$

In equations (1) and (2), SR is the synergistic coefficient of the mixture; X1 is the theoretical EC₅₀ value of the mixture, unit: milligrams per liter (mg/L); X2 is the measured EC₅₀ value of the mixture, unit: milligrams per liter (mg/L).

PA is the percentage content of chlorothalonil in the mixture, unit: percentage (%), and A is the EC₅₀ value of chlorothalonil in the mixture, unit: milligrams per liter (mg/L);

PB is the percentage content of tebuconazole in the mixture, unit: percentage (%), and B is the EC₅₀ value of tebuconazole in the mixture, unit: milligrams per liter (mg/L);

PC is the percentage content of picoxystrobin in the mixture, unit: percentage (%), and C is the EC₅₀ value of picoxystrobin in the mixture, unit: milligrams per liter (mg/L).

The synergistic coefficient (SR) of the binary composition was calculated according to equations (3) and (4):

$${X}_{1}^{′} = \frac{P 1 + P 2}{\frac{{P}_{1}}{{A}_{1}} + \frac{{P}_{2}}{{B}_{1}}} \qquad ( 3 )$$

$$SR = \frac{X {1}^{′}}{X 2} \qquad ( 4 )$$

In equations (3) and (4), SR is the synergistic coefficient of the mixture; X1′ is the theoretical value of the mixture, unit: milligrams per liter (mg/L); X2 is the measured value of the mixture, unit: milligrams per liter (mg/L).

P1 is the percentage content of component A1′ in the mixture, unit: percentage (%), and A1 is the EC₅₀ value of component A1′, unit: milligrams per liter (mg/L).

P2 is the percentage content of component B1′ in the mixture, unit: percentage (%), and B1 is the EC₅₀ value of component B1′, unit: milligrams per liter (mg/L).

Where, components A1′ and B1′ can represent one of two active ingredients in the binary composition mixture, or the component A1′ represents a combination of two active ingredients in the ternary composition mixture, and the component B1′ represents another active ingredient in the ternary composition mixture.

For example, the component A1′ is a combination of chlorothalonil and tebuconazole (A+B), P1 is the percentage content of chlorothalonil and tebuconazole (A+B), A1 is the EC₅₀ value of chlorothalonil and tebuconazole (A+B), correspondingly, P2 is the percentage content of another active ingredient picoxystrobin (C), B1 is the EC₅₀ value of picoxystrobin (C), and the synergistic coefficient SR of chlorothalonil and tebuconazole (A+B)+picoxystrobin C (A+B) +C) is calculated based on this.

Similarly, the synergistic coefficients SRs of chlorothalonil and picoxystrobin (A+C)+tebuconazole (B) (referred to as (A+C)+B), tebuconazole and picoxystrobin (B+C)+chlorothalonil (A) (referred to as (B+C)+A) can be calculated.

TABLE 1
Toxicity measurement results of compounding of chlorothalonil,
picoxystrobin and tebuconazole on grape downy mildew

| | | Theoretical | | Measured | SR |
|---|---|---|---|---|---|
| | | EC₅₀ value | | EC₅₀ value | (synergistic |
| Test pesticides | Ratios | (mg/L) (X1) | | (mg/L) (X2) | coefficient) |
| Chlorothalonil (A) | / | / | | 24.628 | / |
| Tebuconazole (B) | / | / | | 3.29 | / |
| Picoxystrobin (C) | / | / | | 2.48 | / |
| Chlorothalonil:tebuconazole (A + B) | 9:1 | 14.94 | | 14.12 | 1.06 |
| Chlorothalonil:tebuconazole (A + B) | 10:1 | 15.50 | | 10.29 | 1.51 |
| Tebuconazole:picoxystrobin (B + C) | 2:1 | 2.97 | | 2.16 | 1.37 |
| Tebuconazole:picoxystrobin (B + C) | 1:1 | 2.83 | | 1.85 | 1.53 |
| Chlorothalonil:picoxystrobin (A + C) | 18:1 | 16.75 | | 11.12 | 1.51 |
| Chlorothalonil:picoxystrobin (A + C) | 10:1 | 13.59 | | 14.35 | 0.95 |
| Chlorothalonil:picoxystrobin (A + C) | 20:1 | 17.28 | | 10.87 | 1.59 |
| Chlorothalonil:tebuconazole:picoxystrobin | 5:4:1 | 5.49 | | 4.83 | 1.14 |
| Chlorothalonil:tebuconazole:picoxystrobin | 10:3:2 | 7.06 | | 5.35 | 1.32 |
| Chlorothalonil:tebuconazole:picoxystrobin | 50:1:1 | 19.00 | | 16.98 | 1.12 |
| Chlorothalonil:tebuconazole:picoxystrobin | 30:5:3 | 9.63 | | 6.17 | 1.56 |
| Chlorothalonil:tebuconazole:picoxystrobin | 10:6:3 | A + B + C | 5.53 | 2.11 | 2.61 |
| | | A + (B + C) | 4.16 | | 1.97 |
| Chlorothalonil:tebuconazole:picoxystrobin | 10:1:1 | A + B + C | 10.78 | 3.94 | 2.74 |
| | | (A + B) + C | 8.15 | | 2.07 |
| | | A + (B + C) | 8.07 | | 2.05 |
| | | B + (A + C) | 11.21 | | 2.85 |
| Chlorothalonil:tebuconazole:picoxystrobin | 20:2:1 | A + B + C | 12.62 | 3.82 | 3.30 |
| | | (A + B) + C | 9.05 | | 2.37 |
| | | A + (B + C) | 10.45 | | 2.74 |
| | | B + (A + C) | 9.06 | | 2.37 |
| Chlorothalonil:tebuconazole:picoxystrobin | 18:2:1 | A + B + C | 12.06 | 3.16 | 3.82 |
| | | (A + B) + C | 11.54 | | 3.65 |
| | | A + (B + C) | 9.91 | | 3.14 |
| | | B + (A + C) | 9.07 | | 2.87 |

It can be seen from table 1 that the weight ratio of chlorothalonil, tebuconazole and picoxystrobin is (10-20):(1-6):(1-3), which indicates more significant synergistic effect compared with binary compounding, preferably (10-20):(1-2):1,particularly, the weight ratio of chlorothalonil to tebuconazole in the ternary composition is (9-10):1,which indicates significant synergistic effect; further, the weight ratio of chlorothalonil, tebuconazole and picoxystrobin is (18-20):2:1,which indicates more significant synergistic effect compared with binary compounding; more further, the weight ratios of chlorothalonil, tebuconazole and picoxystrobin are 10:6:3, 10:1:1, 20:2:1 and 18:2:1.

To further study the feasible dosage forms of chlorothalonil, tebuconazole and picoxystrobin, picoxystrobin easily forms non-disintegrating particles due to a low melting point, and there is a situation that a large amount of fine powders fail to pass a sieve during the wet screening test, so as to pose certain difficulties in the processing of water dispersible granule formulations.

The inventors conducted extensive screening work on the adjuvant system and ultimately obtained a system with the best matching degree between the above components, especially the screening and combination of a dispersant, a wetting agent, a stabilizer and a filler, greatly reducing the difficulty of processing the dosage form and improving the stability of the dosage form. The formula has the advantages of adapting to multiples water qualities, and low foaming ability and high suspension rate, thereby effectively solving the problems of poor thermal storage stability and processing manufacturability of products. Specifically, ratios of some examples are shown in Table 2.

TABLE 2
Formulae of each example

| | Active | | wetting | Chelating | | |
|---|---|---|---|---|---|---|
| | ingredients | Dispersant | agent | agent | Disintegrant | Filler |
| Example | 30% of | 3% of | 4% of a | 3% of | 10% of | The |
| 1 | chlorothalonil, | styrene- | polymer of | disodium | diammonium | balance |
| | 5% of | acrylic acid | olefin and | ethylenedia | hydrogen | being |
| | tebuconazole, | copolymer | maleic | minetetraacetate | phosphate | talcum |
| | and 3% of | sodium salt, | anhydride | | | powder |
| | picoxystrobin | and 6% of | | | | |
| | | sodium | | | | |
| | | lignosulfonate | | | | |
| Example | 54% of | 5% of | 4% of a | 3% of | 20% of | The |
| 2 | chlorothalonil, | styrene- | polymer of | disodium | diammonium | balance |
| | 6% of | acrylic acid | olefin and | ethylenedia | hydrogen | being |
| | tebuconazole, | copolymer | maleic | minetetraacetate | phosphate | talcum |
| | and 3.3% | sodium salt, | anhydride | | | powder |
| | of | and 5% of | | | | |
| | picoxystrobin | sodium | | | | |
| | | lignosulfonate | | | | |
| Example | 50% of | 5% of | 4% of a | 3% of | 20% of | The |
| 3 | chlorothalonil, | styrene- | polymer of | disodium | diammonium | balance |
| | 1% of | acrylic acid | olefin and | ethylenedia | hydrogen | being |
| | tebuconazol | copolymer | maleic | minetetraacetate | phosphate | talcum |
| | e, and 1% of | sodium salt, | anhydride | | | powder |
| | picoxystrobin | and 5% of | | | | |
| | | sodium | | | | |
| | | lignosulfonate | | | | |
| Example | 50% of | 3% of | 4% of | 3% of | 15% of | The |
| 4 | chlorothalonil, | styrene- | sodium | disodium | diammonium | balance |
| | 5% of | acrylic acid | diisobutyl | ethylenedia | hydrogen | being |
| | tebuconazol | copolymer | naphthalene | minetetraacetic | phosphate | talcum |
| | e, and 5% of | sodium salt, | sulfonate | acid | | powder |
| | picoxystrobin | and 6% of | | | | |
| | | sodium | | | | |
| | | lignosulfonate | | | | |
| Example | 50% of | 3% of | 4% of | 3% of | 15% of | The |
| 5 | chlorothalonil, | styrene- | sodium | sodium | ammonium | balance |
| | 1% of | acrylic acid | diisobutyl | tripolyphosphate | sulfate | being |
| | tebuconazole, | copolymer | naphthalene | | | talcum |
| | and 1% of | sodium salt, | sulfonate | | | powder |
| | picoxystrobin | and 6% of | | | | |
| | | alkylnaphth | | | | |
| | | alene | | | | |
| | | sulfonate | | | | |
| | | formaldehyde | | | | |
| | | condensate | | | | |
| Example | 54% of | 3% of | 4% of | 3% of | 15% of | The |
| 6 | chlorothalonil, | styrene- | sodium | sodium | sodium | balance |
| | 6% of | acrylic acid | diisobutyl | gluconate | sulfate | being |
| | tebuconazole, | copolymer | naphthalene | | | kaolin |
| | and 3.3% | sodium salt, | sulfonate | | | |
| | of | and 6% of | | | | |
| | picoxystrobin | alkylnaphthalene | | | | |
| | | sulfonate | | | | |
| | | formaldehyde | | | | |
| | | condensate | | | | |
| Example | 50% of | 6% of | 4% of fatty | 3% of | 15% of urea | The |
| 7 | chlorothalonil, | sodium | alcohol | sodium | | balance |
| | 5% of | lignosulfonate, | sulfate | pyrophosphate | | being |
| | tebuconazole, | and 3% | | | | diatomite |
| | and 5% of | of | | | | |
| | picoxystrobin | alkylnaphthalene | | | | |
| | | sulfonate | | | | |
| | | formaldehyde | | | | |
| | | condensate | | | | |
| Example | 50% of | 3% of | 4% of | 3% of | 15% of | The |
| 8 | chlorothalonil, | sodium | sodium | disodium | ammonium | balance |
| | 5% of | lignosulfonate, | dodecyl | ethylenedia | sulfate | being |
| | tebuconazole, | and 6% | sulfate | minetetraacetate | | kaolin |
| | and 5% of | of | | | | |
| | picoxystrobin | alkylnaphthalene | | | | |
| | | sulfonate | | | | |
| | | formaldehyde | | | | |
| | | condensate | | | | |
| Example | 50% of | 3% of | 4% of | 3% of | 15% of | The |
| 9 | chlorothalonil, | sodium | sodium | disodium | diammonium | balance |
| | 5% of | lignosulfonate, | dodecyl | ethylenedia | hydrogen | being |
| | tebuconazole, | and 6% | sulfate | minetetraacetate | phosphate | talcum |
| | and 5% of | of | | | | powder |
| | picoxystrobin | alkylnaphthalene | | | | |
| | | sulfonate | | | | |
| | | formaldehyde | | | | |
| | | condensate | | | | |
| Example | 50% of | 3% of | 4% of a | 3% of | 15% of | The |
| 10 | chlorothalonil, | styrene- | polymer of | sodium | ammonium | balance |
| | 5% of | acrylic acid | olefin and | tripolyphosphate | sulfate | being |
| | tebuconazole, | copolymer | maleic | | | kaolin |
| | and 5% of | sodium salt, | anhydride | | | |
| | picoxystrobin | and 6% of | | | | |
| | | sodium | | | | |
| | | lignosulfonate | | | | |

In examples and comparative examples above mentioned, adjuvants and raw materials are both commercially available. For example, the styrene-acrylic acid copolymer sodium salt is purchased from Solvay Chemical, alkylnaphthalene sulfonate-formaldehyde concentrate is purchased from Nanjing Jierun Technology Co., Ltd., and the polymer of olefin and maleic anhydride is purchased from Shanghai Moqin New Materials Co., Ltd.

The preparation method of the water dispersible granules in Examples 1-10 above mentioned includes the following steps: chlorothalonil, tebuconazole, picoxystrobin, a dispersant, a wetting agent, a disintegrant, a chelating agent and a filler were evenly mixed, ultrafine airflow pulverization was performed on the obtained mixture to preferably obtain fine powders with a particle size of 400-800 meshes, the obtained fine powders were mixed with water and kneaded, wherein the addition amount of water was 16-22% of the total mass of materials. After kneading, the kneaded mixture was subjected to extrusion granulation and then dried (preferably the obtained particles were dried at 45-55° C.) to obtain the water dispersible granule product containing chlorothalonil, tebuconazole and picoxystrobin.

The performances of the water dispersible granules prepared in the above examples were detected. The results are shown in Table 3 below.

The suspension rates of different water qualities (C water: a hardness of 500 mg/L, pH=7.0-8.0; 3WHO water: a hardness of 1026 mg/L, pH =6.0-7.0) were tested according to CIPAC MT184,screening (wet screening test) was detected according to CIPAC MT185,persistent foaming was detected according to CIPAC MT47.2,and thermal storage stability was measured according to the requirements of solid formulations under GB/T 19136.

Disintegrability is expressed by the measured disintegration time, which is generally less than 3 min as qualified. The measurement method is as follows: at 25° C., 0.5 g of sample particles were added to a 100 mL stoppered measuring cylinder (with a height of 22.5 cm and an inner diameter of 28 mm) containing 90 mL of distilled water, was clamped in the middle of the cylinder, and rotated uniformly along the center at a speed of 8 r/min until the sample had completed disintegration in water. The time was recorded, which is the disintegration time.

TABLE 3
Performance detection results of water dispersible granules prepared by
compounding chlorothalonil, tebuconazole and picoxystrobin

| | Detection index | | | | | | | | | |
|---|---|---|---|---|---|---|---|---|---|---|
| | Before thermal storage | | | | | After thermal storage for 14 d | | | | |
| | | | | C water | 3WHO | | | | C water | 3WHO |
| | Dis- | | Persistent | sus- | water | Dis- | | Persistent | sus- | water |
| Treatment | integration, | Screening, | foaming, | pension | suspension | integration, | Screening, | foaming, | pension | suspension |
| Pesticide | s | % | mL | rate, % | rate, % | s | % | mL | rate, % | rate, % |
| Example 1 | 52 | 99.9 | 4 | 93.5 | 92.1 | 52 | 99.9 | 4 | 92.1 | 91.6 |
| Example 2 | 48 | 99.9 | 4 | 96.8 | 96.5 | 47 | 99.9 | 4 | 96.4 | 96 |
| Example 3 | 50 | 99.9 | 4 | 96 | 95.6 | 50 | 99.9 | 4 | 95.8 | 95 |
| Example 4 | 60 | 99.9 | 40 | 90.6 | 90 | 60 | 99.9 | 48 | 90.4 | 89.5 |
| Example 5 | 80 | 95.6 fine | 46 | 82.6 | 78.2 | 140 | 91.2, fine | 48 | 65.3 | 62.3 |
| | | powders | | | | | powders, | | | |
| | | | | | | | particles | | | |
| Example 6 | 90 | 91.9 fine | 48 | 70 | 63 | 108 | 91.2, fine | 50 | 48.1 | 38, 5.2 |
| | | powders | | | | | powders, | | | |
| | | | | | | | particles | | | |
| Example 7 | 92 | 91.5 fine | 68 | 75.5 | 73.6 | 118 | 80.2, a few of | 70 | 62.2 | 61 |
| | | powders | | | | | fine powders, | | | |
| | | | | | | | particles | | | |
| Example 8 | 90 | 4.1 fine | 80 | 840 | 82.4 | 110 | 85.1, a large | 90 | 54.1 | 50.6 |
| | | powders | | | | | amount of fine | | | |
| | | | | | | | powders, | | | |
| | | | | | | | particles | | | |
| Example 9 | 90 | 98.0 fine | 80 | 82 | 81.4 | 140 | 80.2, a large | 90 | 55.1 | 56.6 |
| | | powders | | | | | amount of fine | | | |
| | | | | | | | powders, | | | |
| | | | | | | | particles | | | |
| Example 10 | 70 | 99.8 | 4 | 90 | 88.9 | 80 | 99.5, tiny fine | 10 | 86.9 | 88.3 |
| | | | | | | | powders | | | |

It can be seen from data in Table 3 that the suspension rates of the water dispersible granules prepared in Examples 1-4 are remained at a high level before and after thermal storage, especially suspension rates in Examples 2 and 3 are remained at about 95%, without fine powders appeared during the screening. The water dispersible granules have good thermal storage stability, fast disintegration time and relatively low persistent foaming ability; Examples 5-10 show poor quality before and after thermal storage, while there is a significant decrease in quality after thermal storage.

Examples 1-4 show that under the condition of selecting the preferred adjuvants, the performances of the water dispersible granules obtained when the contents of the active ingredients of the pesticides change within the optimal ratio range are close. This indicates that the pesticide content has relatively small influence on the performances of the dosage form when the ingredient and content of the preferred adjuvants are used. It can be seen from Examples 5-10 that in the case that under the condition that an ordinary adjuvant is used, the performances of the obtained water dispersible granule are relatively poor, and there is no significant improvement after the replacement of adjuvants, indicating that the ingredient and content of the preferred adjuvant, rather than the ordinary adjuvant, have a significant improvement effect on the performances of the water dispersible granules formed by compounding chlorothalonil, tebuconazole and picoxystrobin.

### Field Experiment Example 1

This test was conducted in a grape planting greenhouse and wheat field of a farmer household in the suburb of Weifang City, Shandong Province. Different planting areas were set. The pesticide was sprayed, and test plots were randomly arranged. In the test, blank control treatment and pesticide treatment were set, with a total of 4 treatments, respectively including Treatment 1: clear water spray, blank control group; Treatment 2: the water dispersible granules of chlorothalonil, tebuconazole and picoxystrobin obtained from Examples 1-10; Treatment 3: 75% tebuconazole·chlorothalonil wettable powders (commercially available); Treatment 4: 75% chlorothalonil wettable powders (commercially available).

In the early stage of downy mildew in the grape shed, the relevant spray treatment was conducted once with Gongnong-16 backpack manual spray, and in Treatment 2 example, the spray treatment was conducted according to the effective ingredient dosage of 1000 g/ha; Treatment 3: spray was conducted according to the effective ingredient 1500 g/ha; Treatment 4: spray was conducted according to the dosage of effective ingredients 1600 g/ha. Gongnong-16 knapsack type manual spray was used to apply the pesticide once, 750 L of water was mixed with the amount of preparation per ha to prepare the pesticide liquid, and the amount of pesticide liquid in a community was calculated for even spray. Random block arrangement was used, with 4 repetitions, with a community area of 20 m² (10 m×2 m).

In the early stage of wheat powdery mildew, spray treatment was carried out to prevent and control powdery mildew. Gongnong-16 backpack manual spray was used to apply the pesticide once. In Treatment 2 example, spray treatment was carried out according to the amount of effective ingredients 800 g/ha; Treatment 3: the active ingredient was sprayed based on the amount 1200 g/ha of active ingredients; Treatment 4: spray was conducted according to the amount 1400 g/ha of active ingredients. 750 L of water was mixed with the amount of preparation per ha to prepare the pesticide liquid, and the amount of pesticide liquid in a community was calculated for even spray. Random block arrangement was used with 4 repetitions, with a community area of 50 m² (10 m×5 m).

Survey method: 4 points were fixed in each community, each with an area of 4 m². The disease index in the community was surveyed 30 days after the application of pesticides, and the prevention and control effect was calculated. The calculation equation is as follows:

The survey method for disease index is based on the following grading standards and calculation formula for disease index:
Level 0: no lesions;
Level 1: the lesion area accounts for less than 5% of the entire leaf area;
Level 3: The lesion area accounts for 6-10% of the entire leaf area;
Level 5: The lesion area accounts for 11%- 25% of the entire leaf area;
Level 7: The lesion area accounts for 26%- 50% of the entire leaf area;
Level 9: The lesion area accounts for more than 50% of the entire leaf area;

$$Disease index = 100 \times \sum ( Number of diseased leaves at all levels \times Representative values at all levels ) / ( Total number of surveyed leaves \times The highest representative value )$$

$$Prevention and control effect , \% = ( Control area disease index - Treatment area disease index ) / Control area disease index ) * 100$$

TABLE 4
Prevention and control effects of various treatment agents on
grape downy mildew pathogen and wheat powdery mildew pathogen

| | | Prevention and | Prevention and |
|---|---|---|---|
| | | control effect | control effect |
| | | of grape downy | of wheat powdery |
| | | mildew, % | mildew, % |
| Treatment 2 | Example 1 | 91.76 | 96.54 |
| | Example 2 | 97.25 | 98.11 |
| | Example 3 | 91.76 | 96.86 |
| | Example 4 | 84.62 | 91.19 |
| | Example 5 | 76.37 | 87.42 |
| | Example 6 | 68.33 | 72.33 |
| | Example 7 | 71.50 | 81.33 |
| | Example 8 | 78.33 | 85.33 |
| | Example 9 | 75.17 | 86.33 |
| | Example 10 | 85.17 | 88.17 |
| Treatment 3 | 75% tebucona- | 74.73 | 86.16 |
| | zole•chlorothalonil | | |
| | wettable powde | | |
| Treatment 4 | 75% chlorothalonil | 40.66 | 47.80 |
| | wettable powde | | |
| Treatment 1 | Clear water spraying | 0 | 0 |

It can be seen from the test results in the above table that the ternary composition by compounding chlorothalonil, tebuconazole and picoxystrobin has a good prevention and control effect on grape downy mildew and wheat powdery mildew. Comparing Examples 1-4 with Examples 5-10,an obvious synergistic effect is created between the ternary composition and the adjuvants, thereby improving the prevention and control effect of pesticides. It is indicated that the specific adjuvant combination of the present application not only ensures good physical performance, but also improves the field sterilization and control effect. The present application has a prevention and control effect of over 90% in preventing and controlling grape downy mildew and wheat powdery mildew, and the composition ratios of the present application can better play the role in pesticide synergy, reduce the usage amount of pesticides and improve the efficacy.

The pesticide composition provided by the present application has a high content and reduced the amount and frequency of bactericide, thereby reducing the cost of the pesticide.

In the present application, a large amount of screening works are conducted on the adjuvant system to ultimately obtain a system with the best matching degree among the above components. The formula is suitable for multiple water qualities, and has low foaming ability and high suspension rate. The efficacy is good.

The water dispersible granule of the present application is suitable for multiple water qualities, and has the advantages of low foaming ability and high suspension rate. The optimal combination of the stabilizer and the filler greatly reduces the processing difficulty of the dosage form and improves the stability of the dosage form.

Finally, it should be noted that the above examples are only used to illustrate the technical solution of the present application, not to limit the technical solution of the present application; although the present application has been described in detail with reference to the aforementioned examples, ordinary technical personnel in this field should understand that they can still modify the technical solutions recorded in the aforementioned examples or equivalently replace some of the technical features; And these modifications or substitutions do not separate the essence of the corresponding technical solutions from the spirit and scope of the various examples of the present application.

### INDUSTRIAL APPLICABILITY

The present application discloses a pesticide bactericidal composition, a water dispersible granule and a preparation method and a use thereof. The active ingredients of the pesticide bactericidal composition comprise chlorothalonil, tebuconazole and picoxystrobin with a weight ratio of (10-50):(1-2):1.The ternary compounded composition of the present application has a synergistic effect in the aspect of preventing and controlling plant diseases, and can achieve above 90% of prevention and control effect of grape downy mildew and wheat powdery mildew. The ratios of the composition in the present application can allow pesticides to better exert a synergistic effect, thereby reducing the usage amount of the pesticides and improving the efficacy.

What is claimed is:

1. A pesticide bactericidal composition, comprising the following active ingredients: chlorothalonil, tebuconazole and picoxystrobin with a weight ratio of (10-50):(1-6):(1-3).

2. The pesticide bactericidal composition according to claim 1, wherein the weight ratio of chlorothalonil, tebuconazole and picoxystrobin is (10-20):(1-6):(1-3), optionally (10-20):(1-2):1 or 10:6:3,optionally (18-20):2:1 or 10:6:3,optionally 10:6:3, 10:1:1, 20:2:1 and 18:2:1;
and/or, the weight ratio of chlorothalonil to tebuconazole is (9-10):1.

3. The pesticide bactericidal composition according to claim 1, wherein the active ingredients account for 1-99%, optionally 20%- 80%, optionally 30%- 70%, optionally 50%- 70%, optionally 38%- 63.3%, of a total weight of the composition.

4. The pesticide bactericidal composition according to claim 2, wherein the active ingredients account for 1-99%, optionally 20%- 80%, optionally 30%- 70%, optionally 50%- 70%, optionally 38%- 63.3%, of a total weight of the composition.

5. The pesticide bactericidal composition according to claim 1, wherein a dosage form of the pesticide bactericidal composition is one or more of a missible oil, a microcapsule suspension-suspending agent, a suspension emulsion, an emulsion in water, a microemulsion, a soluble concentrate or a wettable powder;
optionally, the pesticide bactericidal composition further comprises an adjuvant, optionally, the adjuvant is one or more selected from the group consisting of a dispersant, a wetting agent, an emulsifier, a solvent, a cosolvent, an antifreeze, a chelating agent, a disintegrant, a stabilizer, a preservative, a thickener, a binder, a defoamer, an acid adjusting medium, an alkali adjusting media, and a solid inert carrier.

6. The pesticide bactericidal composition according to claim 2, wherein a dosage form of the pesticide bactericidal composition is one or more of a missible oil, a microcapsule suspension-suspending agent, a suspension emulsion, an emulsion in water, a microemulsion, a soluble concentrate or a wettable powder;
optionally, the pesticide bactericidal composition further comprises an adjuvant, optionally, the adjuvant is one or more selected from the group consisting of a dispersant, a wetting agent, an emulsifier, a solvent, a cosolvent, an antifreeze, a chelating agent, a disintegrant, a stabilizer, a preservative, a thickener, a binder, a defoamer, an acid adjusting medium, an alkali adjusting media, and a solid inert carrier.

7. The pesticide bactericidal composition according to claim 3, wherein a dosage form of the pesticide bactericidal composition is one or more of a missible oil, a microcapsule suspension-suspending agent, a suspension emulsion, an emulsion in water, a microemulsion, a soluble concentrate or a wettable powder;
optionally, the pesticide bactericidal composition further comprises an adjuvant, optionally, the adjuvant is one or more selected from the group consisting of a dispersant, a wetting agent, an emulsifier, a solvent, a cosolvent, an antifreeze, a chelating agent, a disintegrant, a stabilizer, a preservative, a thickener, a binder, a defoamer, an acid adjusting medium, an alkali adjusting media, and a solid inert carrier.

8. The pesticide bactericidal composition according to claim 5, wherein the dispersant is one or more selected from the group consisting of styrene-acrylic acid copolymer sodium salt, methylnaphthalene sulfonic acid-formaldehyde concentrate sulfate, naphthalene sulfonic acid-formaldehyde condensate sodium salt, methylene naphthalene sodium sulfonate-dibutylnaphthalene sulfonic acid-formaldehyde concentrate, sodium N-methyl fatty acyl taurine, alkylnaphthalene sulfonate-formaldehyde concentrate, alkylphenol ethoxylate-formaldehyde concentrate sulfate and sodium lignosulfonate, preferably in the dispersant, a weight ratio of styrene-acrylic acid copolymer sodium salt to sodium lignosulfonate is (1-2):1,preferably 1:1;
and/or, the wetting agent is one or more selected from the group consisting of sodium dodecyl sulfate, a-sulfo fatty acid methyl ester, sodium tetradecyl sulfate, sodium dodecyl benzenesulfonate, sodium alkylnaphthalene sulfonate, sodium a-olefin sulfonate, a polymer of olefin and maleic anhydride, sodium alkylphenol polyoxyethylene ether sulfate, sodium diisobutylnaphthalene sulfonate, fatty acid sulfate and fatty acid ester sulfate, optionally a polymer of olefin and maleic anhydride and/or sodium diisobutylnaphthalene sulfonate;
and/or, the chelating agent is one or more selected from the group consisting of sodium tripolyphosphate, sodium gluconate, sodium pyrophosphate and disodium ethylenediaminetetraaceticate, optionally disodium ethylene diamine tetraaceticate and/or sodium tripolyphosphate;
and/or, the disintegrant is one or more selected from the group consisting of urea, sodium sulfate, ammonium sulfate, calcium chloride, potassium dihydrogen phosphate and diammonium hydrogen phosphate, optionally diammonium hydrogen phosphate and/or ammonium sulfate;
and/or, the adjuvant comprises the dispersant, the wetting agent, the chelating agent and the disintegrant with a weight ratio of (5-20):(3-8):3:(5-30), optionally (9-15):(4-8):3:(10-25), optionally (9-10):4:3:(10-20), optionally 10:4:3:20; optionally the adjuvant further comprises a filler;
and/or, the filler comprises one or more of talcum powder, corn starch, kaolin, silica and kieselguhr; optionally, talcum powder and/or kaolin.

9. The pesticide bactericidal composition according to claim 6, wherein the dispersant is one or more selected from the group consisting of styrene-acrylic acid copolymer sodium salt, methylnaphthalene sulfonic acid-formaldehyde concentrate sulfate, naphthalene sulfonic acid-formaldehyde condensate sodium salt, methylene naphthalene sodium sulfonate-dibutylnaphthalene sulfonic acid-formaldehyde concentrate, sodium N-methyl fatty acyl taurine, alkylnaphthalene sulfonate-formaldehyde concentrate, alkylphenol ethoxylate-formaldehyde concentrate sulfate and sodium lignosulfonate, preferably in the dispersant, a weight ratio of styrene-acrylic acid copolymer sodium salt to sodium lignosulfonate is (1-2):1,preferably 1:1;
and/or, the wetting agent is one or more selected from the group consisting of sodium dodecyl sulfate, a-sulfo fatty acid methyl ester, sodium tetradecyl sulfate, sodium dodecyl benzenesulfonate, sodium alkylnaphthalene sulfonate, sodium a-olefin sulfonate, a polymer of olefin and maleic anhydride, sodium alkylphenol polyoxyethylene ether sulfate, sodium diisobutylnaphthalene sulfonate, fatty acid sulfate and fatty acid ester sulfate, optionally a polymer of olefin and maleic anhydride and/or sodium diisobutylnaphthalene sulfonate;
and/or, the chelating agent is one or more selected from the group consisting of sodium tripolyphosphate, sodium gluconate, sodium pyrophosphate and disodium ethylenediaminetetraaceticate, optionally disodium ethylene diamine tetraaceticate and/or sodium tripolyphosphate;
and/or, the disintegrant is one or more selected from the group consisting of urea, sodium sulfate, ammonium sulfate, calcium chloride, potassium dihydrogen phosphate and diammonium hydrogen phosphate, optionally diammonium hydrogen phosphate and/or ammonium sulfate;
and/or, the adjuvant comprises the dispersant, the wetting agent, the chelating agent and the disintegrant with a weight ratio of (5-20):(3-8):3:(5-30), optionally (9-15):(4-8):3:(10-25), optionally (9-10):4:3:(10-20), optionally 10:4:3:20; optionally the adjuvant further comprises a filler;
and/or, the filler comprises one or more of talcum powder, corn starch, kaolin, silica and kieselguhr; optionally, talcum powder and/or kaolin.

10. A pesticide bactericidal water dispersible granule, comprising the following raw materials in percentage by weight: 10-60% of chlorothalonil, 1-10% of tebuconazole, 1-10% of picoxystrobin, 6-10% of a dispersant, 2-6% of a wetting agent, 2-4% of a chelating agent, 10-20% of a disintegrant and a balance being a filler.

11. The pesticide bactericidal water dispersible granule according to claim 10, comprising the following raw materials in percentage by weight: 30-60% of chlorothalonil, 1-10% of tebuconazole, 1-10% of picoxystrobin, 9-10% of the dispersant, 3-5% of the wetting agent, 3-4% of the chelating agent, 10-20% of the disintegrant and the balance being the filler;
optionally, comprising the following raw materials in percentage by weight: 30-60% of chlorothalonil, 1-10% of tebuconazole, 1-10% of picoxystrobin, 9-10% of the dispersant, 4% of the wetting agent, 3% of a chelating agent, 10-20% of the disintegrant and the balance being the filler;
optionally, comprising the following raw materials in percentage by weight: 30-54% of chlorothalonil, 1-6% of tebuconazole, 1-5% of picoxystrobin, 9-10% of the dispersant, 4% of the wetting agent, 3% of the chelating agent, 10-20% of the disintegrant and the balance being the filler;
optionally, comprising the following raw materials in percentage by weight: 30-54% of chlorothalonil, 1-6% of tebuconazole, 1-3.3% of picoxystrobin, 9-10% of the dispersant, 4% of the wetting agent, 3% of the chelating agent, 10-20% of the disintegrant and the balance being the filler;
optionally, comprising the following raw materials in percentage by weight: 30-60% of chlorothalonil, 1-10% of tebuconazole, 1-10% of picoxystrobin, 10% of the dispersant, 4% of the wetting agent, 3% of the chelating agent, 20% of the disintegrant and the balance being the filler;
optionally, comprising the following raw materials in percentage by weight: 30-54% of chlorothalonil, 1-6% of tebuconazole, 1-5% of picoxystrobin, 10% of the dispersant, 4% of the wetting agent, 3% of the chelating agent, 20% of the disintegrant and the balance being the filler;
optionally, comprising the following raw materials in percentage by weight: 50-54% of chlorothalonil, 1-6% of tebuconazole, 1-3.3% of picoxystrobin, 10% of the dispersant, 4% of the wetting agent, 3% of the chelating agent, 20% of the disintegrant and the balance being the filler;
optionally, comprising the following raw materials in percentage by weight: 54% of chlorothalonil, 6% of tebuconazole, 3.3% of picoxystrobin, 10% of the dispersant, 4% of the wetting agent, 3% of the chelating agent, 20% of the disintegrant and the balance being the filler.

12. The pesticide bactericidal water dispersible granule according to claim 10, wherein the dispersant is one or more selected from the group consisting of styrene-acrylic acid copolymer sodium salt, methylnaphthalene sulfonic acid-formaldehyde concentrate sulfate, naphthalene dibutylnaphthalene sulfonic acid-formaldehyde concentrate, sodium N-methyl fatty acyl taurine, alkylnaphthalene sulfonate-formaldehyde concentrate, alkylphenol ethoxylate-formaldehyde concentrate sulfate and sodium lignosulfonate, preferably in the dispersant, a weight ratio of styrene-acrylic acid copolymer sodium salt to sodium lignosulfonate is (1-2):1,preferably 1:1;
and/or, the wetting agent is one or more selected from the group consisting of sodium dodecyl sulfate, a-sulfo fatty acid methyl ester, sodium tetradecyl sulfate, sodium dodecyl benzenesulfonate, sodium alkylnaphthalene sulfonate, sodium a-olefin sulfonate, a polymer of olefin and maleic anhydride, sodium alkylphenol polyoxyethylene ether sulfate, sodium diisobutylnaphthalene sulfonate, fatty acid sulfate and fatty acid ester sulfate, optionally a polymer of olefin and maleic anhydride and/or sodium diisobutylnaphthalene sulfonate;
and/or, the chelating agent is one or more selected from the group consisting of sodium tripolyphosphate, sodium gluconate, sodium pyrophosphate and disodium ethylenediaminetetraaceticate, optionally disodium ethylene diamine tetraaceticate and/or sodium tripolyphosphate;
and/or, the disintegrant is one or more selected from the group consisting of urea, sodium sulfate, ammonium sulfate, calcium chloride, potassium dihydrogen phosphate and diammonium hydrogen phosphate, optionally diammonium hydrogen phosphate and/or ammonium sulfate;
and/or, the filler comprises one or more of talcum powder, corn starch, kaolin, silica and kieselguhr; optionally, talcum powder and/or kaolin;
and/or, the weight ratio of the dispersant, the wetting agent, the chelating agent and the disintegrant is (5-20):(3-8):3:(5-30), optionally (9-15):(4-8):3:(10-25), optionally (9-10):4:3:(10-20), optionally 10:4:3:20.

13. The pesticide bactericidal water dispersible granule according to claim 11, wherein the dispersant is one or more selected from the group consisting of styrene-acrylic acid copolymer sodium salt, methylnaphthalene sulfonic acid-formaldehyde concentrate sulfate, naphthalene dibutylnaphthalene sulfonic acid-formaldehyde concentrate, sodium N-methyl fatty acyl taurine, alkylnaphthalene sulfonate-formaldehyde concentrate, alkylphenol ethoxylate-formaldehyde concentrate sulfate and sodium lignosulfonate, preferably in the dispersant, a weight ratio of styrene-acrylic acid copolymer sodium salt to sodium lignosulfonate is (1-2):1,preferably 1:1;
and/or, the wetting agent is one or more selected from the group consisting of sodium dodecyl sulfate, a-sulfo fatty acid methyl ester, sodium tetradecyl sulfate, sodium dodecyl benzenesulfonate, sodium alkylnaphthalene sulfonate, sodium a-olefin sulfonate, a polymer of olefin and maleic anhydride, sodium alkylphenol polyoxyethylene ether sulfate, sodium diisobutylnaphthalene sulfonate, fatty acid sulfate and fatty acid ester sulfate, optionally a polymer of olefin and maleic anhydride and/or sodium diisobutylnaphthalene sulfonate;
and/or, the chelating agent is one or more selected from the group consisting of sodium tripolyphosphate, sodium gluconate, sodium pyrophosphate and disodium ethylenediaminetetraaceticate, optionally disodium ethylene diamine tetraaceticate and/or sodium tripolyphosphate;
and/or, the disintegrant is one or more selected from the group consisting of urea, sodium sulfate, ammonium sulfate, calcium chloride, potassium dihydrogen phosphate and diammonium hydrogen phosphate, optionally diammonium hydrogen phosphate and/or ammonium sulfate;
and/or, the filler comprises one or more of talcum powder, corn starch, kaolin, silica and kieselguhr; optionally, talcum powder and/or kaolin;
and/or, the weight ratio of the dispersant, the wetting agent, the chelating agent and the disintegrant is (5-20):(3-8):3:(5-30), optionally (9-15):(4-8):3:(10-25), optionally (9-10):4:3:(10-20), optionally 10:4:3:20.

14. A method for preparing the pesticide bactericidal composition according to claim 1, comprising:
evenly mixing chlorothalonil, tebuconazole, picoxystrobin and the adjuvants, and then performing ultrafine airflow pulverization on an obtained mixture to obtain fine powders, mixing the obtained fine powders with water and then kneading the obtained mixture, performing extrusion granulation on the mixture after kneading, and then drying an obtained granules to obtain a water dispersible granule product containing chlorothalonil, tebuconazole and picoxystrobin;
optionally, a fineness of the fine powders after ultrafine airflow pulverization is 400-800 meshes;
optionally, an addition amount of water to the fine powders is 16-22% of a total amount of materials;
optionally, a drying temperature after granulation being 45-55° C.

15. A method for preparing the pesticide bactericidal composition according to claim 5, comprising:
evenly mixing chlorothalonil, tebuconazole, picoxystrobin and the adjuvants, and then performing ultrafine airflow pulverization on an obtained mixture to obtain fine powders, mixing the obtained fine powders with water and then kneading the obtained mixture, performing extrusion granulation on the mixture after kneading, and then drying an obtained granules to obtain a water dispersible granule product containing chlorothalonil, tebuconazole and picoxystrobin;
optionally, a fineness of the fine powders after ultrafine airflow pulverization is 400-800 meshes;
optionally, an addition amount of water to the fine powders is 16-22% of a total amount of materials;
optionally, a drying temperature after granulation being 45-55° C.

16. A method for preparing the pesticide bactericidal water dispersible granule according to claim 10, comprising:
evenly mixing chlorothalonil, tebuconazole, picoxystrobin and the adjuvants, and then performing ultrafine airflow pulverization on an obtained mixture to obtain fine powders, mixing the obtained fine powders with water and then kneading the obtained mixture, performing extrusion granulation on the mixture after kneading, and then drying an obtained granules to obtain a water dispersible granule product containing chlorothalonil, tebuconazole and picoxystrobin;
optionally, a fineness of the fine powders after ultrafine airflow pulverization is 400-800 meshes;
optionally, an addition amount of water to the fine powders is 16-22% of a total amount of materials;
optionally, a drying temperature after granulation being 45-55° C.

17. A method for preventing and controlling plant diseases in agricultural fields by the pesticide bactericidal composition according to claim 1; optionally, the plant diseases comprising one or more of downy mildew, powdery mildew, grey mold and rust; optionally the plant diseases comprising one or more of grape downy mildew, wheat powdery mildew and soybean rust.

18. A method for preventing and controlling plant diseases in agricultural fields by the pesticide bactericidal water dispersible granule according to claim 10; optionally, the plant diseases comprising one or more of downy mildew, powdery mildew, grey mold and rust;
optionally the plant diseases comprising one or more of grape downy mildew, wheat powdery mildew and soybean rust.

19. A method for preventing and controlling plant diseases in agricultural fields by the pesticide bactericidal composition prepared by using the method according to claim 14; optionally, the plant diseases comprising one or more of downy mildew, powdery mildew, grey mold and rust; optionally the plant diseases comprising one or more of grape downy mildew, wheat powdery mildew and soybean rust.

20. A method for preventing and controlling plant diseases in agricultural fields by the water dispersible granule prepared by using the method according to claim 16; optionally, the plant diseases comprising one or more of downy mildew, powdery mildew, grey mold and rust;
optionally the plant diseases comprising one or more of grape downy mildew, wheat powdery mildew and soybean rust.
